(19) United States
(12) Patent Application Publication
(10) Pub. No.: US 2026/0128358 A1
(43) Pub. Date: May 7, 2026

(54) Manufacturing Apparatus and Manufacturing Method for Battery Cell

(71) Applicant: SK On Co., Ltd., Seoul (KR)

(72) Inventors: Taek Eon JEONG, Daejeon (KR); Eun Soo CHO, Daejeon (KR)

(21) Appl. No.: 19/380,011

(22) Filed: Nov. 5, 2025

(30) Foreign Application Priority Data
Nov. 7, 2024 (KR) 10-2024-0157173

(51) Int. Cl. H01M 10/04; H01M 10/44; H01M 50/186

(52) U.S. Cl. CPC H01M 10/0468; H01M 10/0481; H01M 10/446; H01M 50/186

(57) ABSTRACT

A manufacturing apparatus for a battery cell according to an embodiment of the present disclosure may include: a plurality of pressurizing blocks pressurizing an external surface of an external material accommodating an electrode assembly including a cathode plate and an anode plate, respectively including an active material region formed by coating an electrode active material and a non-coated region not coated with the electrode active material, and the plurality of pressurizing blocks may include: a plurality of first pressurizing blocks pressurizing a region corresponding to the active material region in the external material; a plurality of second pressurizing blocks pressurizing a region corresponding to a sealing region of the external material; and a plurality of third pressurizing blocks interposed between the plurality of first pressurizing blocks and the plurality of second pressurizing blocks and moving in a width direction of the electrode assembly.

### CROSS-REFERENCE TO RELATED APPLICATIONS

This patent document claims the priority and benefits of Korean Patent Application No. 10-2024-0157173 filed on November 7, 2024, the disclosure of which is incorporated herein by reference in its entirety.

### TECHNICAL FIELD

The present disclosure relates to a manufacturing apparatus and a manufacturing method for a battery cell.

### BACKGROUND

Battery cells are widely used not only in small electronic devices such as mobile phones and laptops, but also in medium-scale to large-scale mechanical devices such as electric vehicles (EV), and offer the advantage of being rechargeable and reusable.

An electrode assembly may be configured from electrode plates, including a cathode plate and an anode plate, with a separator separating the cathode plate and the anode plate. The electrode assembly, manufactured in a stacked, stack-folded, or wound configuration, is then housed in a case selected for the intended use thereof, such as a pouch having a square, or cylindrical shape, and after injecting the electrolyte, the case is sealed to manufacture the cell.

Among the battery cell manufacturing processes, a formation process may include a press pre-charge (PPC) process.

The PPC process involves filling a battery cell with electrolyte, applying pressure to the battery cell, and activating the battery cell through a pre-charge. The PPC process is an activation process that forms an SEI film on a surface of the anode plate. Gases may be generated due to a film formation side reaction. The gases generated during this process may be discharged to a separate gas storage space, but when a large amount of gas is generated, this may cause premature venting of the battery cell.

### SUMMARY

According to an aspect of the present disclosure, a manufacturing apparatus and a manufacturing method of a battery cell that may improve a battery cell quality are provided.

Additionally, according to an aspect of the present disclosure, a manufacturing apparatus and a manufacturing method of a battery cell that may suppress premature venting of a battery cell are provided.

Additionally, the present disclosure may be widely applied in green technology fields such as solar power generation and wind power generation.

Additionally, the present disclosure may be applied to eco-friendly devices such as eco-friendly electric vehicles and hybrid vehicles, for ameliorating the effects of climate change by suppressing air pollution and greenhouse gas emissions.

A manufacturing apparatus for a battery cell according to an embodiment of the present disclosure may include: a plurality of pressurizing blocks pressurizing an external surface of an external material accommodating an electrode assembly including a cathode plate and an anode plate, respectively including an active material region formed by coating an electrode active material and a non-coated region not coated with the electrode active material, and the plurality of pressurizing blocks may include: a plurality of first pressurizing blocks pressurizing a region corresponding to the active material region in the external material; a plurality of second pressurizing blocks pressurizing a region corresponding to a sealing region of the external material; and a plurality of third pressurizing blocks interposed between the plurality of first pressurizing blocks and the plurality of second pressurizing blocks and moving in a width direction of the electrode assembly.

In an embodiment, the manufacturing apparatus for a battery cell may further include: at least one elastic member disposed between the plurality of second pressurizing blocks and the plurality of third pressurizing blocks.

In an embodiment, the at least one elastic member may be provided in plural.

In an embodiment, the at least one elastic member may be stretched or contracted in a width direction of the electrode assembly.

In an embodiment, the plurality of third pressurizing blocks may include a notch or a groove on a surface in contact with the external material.

In an embodiment, the plurality of elastic members may be stacked in a thickness direction of the electrode assembly.

In an embodiment, the manufacturing apparatus for a battery cell may further include: an actuator connected to at least one pressurizing block of the plurality of pressurizing blocks, and bringing the at least one pressurizing block of the plurality of pressurizing blocks into close contact with the external material.

In an embodiment, the plurality of first pressurizing blocks, the plurality of second pressurizing blocks and the plurality of third pressurizing blocks may pressurize an external surface of the external material in a thickness direction of the external material.

In an embodiment, a width of the plurality of first pressurizing blocks in a thickness direction cross-section of the external material may be a value equal to 0.9 times or more and 1.1 times or less of a width of the active material region, and a width of the plurality of second pressurizing blocks in the thickness direction cross-section of the external material may be a value equal to 0.9 times or more and 1.1 times or less of a width of the sealing region.

In an embodiment, the at least one elastic member may include a material including at least one of polymer, urethane or rubber.

In an embodiment, the manufacturing apparatus for a battery cell may further include: a voltage supply unit connected to the cathode plate and the anode plate and applying voltage.

Meanwhile, according to another aspect, the present disclosure provides a manufacturing method for a battery cell.

A manufacturing method for a battery cell according to an embodiment of the present disclosure may manufacture a battery cell by pressurizing an external surface of an external material accommodating an electrode assembly including a cathode plate and an anode plate, respectively including an active material region formed by coating an electrode active material and a non-coated region not coated with the electrode active material, and may include a pressurizing operation of pressurizing the external material with a plurality of pressurizing blocks; and a voltage applying operation of applying voltage to the cathode plate and the anode plate.

In an embodiment, the pressurizing operation may include: pressurizing a first region, a region corresponding to the active material region in the external material, with a plurality of first pressurizing blocks; pressurizing a second region, a region corresponding to a sealing region of the external material, with a plurality of second pressurizing blocks; and pressurizing a terrace region disposed between the sealing region and the active material region in the external material, with a plurality of third pressurizing blocks.

In an embodiment, the manufacturing method for a battery cell may further include: a setting operation of determining an elastic modulus of an elastic member connecting the plurality of second pressurizing blocks and the plurality of third pressurizing blocks, and the setting operation may include determining the elastic modulus of the elastic member based on the silicon content of the electrode active material.

In an embodiment, the setting operation may determine the elastic modulus so that a silicon content of the electrode active material is proportional to the elastic modulus.

According to an aspect of the present disclosure, a manufacturing apparatus and a manufacturing method of a battery cell that may improve battery cell quality may be provided.

Additionally, according to an aspect of the present disclosure, a manufacturing apparatus and a manufacturing method of a battery cell that may suppress premature venting of a battery cell may be provided.

Additionally, the present disclosure may be widely applied in green technology fields such as solar power generation and wind power generation.

Additionally, the present disclosure may be applied to eco-friendly devices such as eco-friendly electric vehicles and hybrid vehicles, for ameliorating the effects of climate change by reducing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a schematic cross-sectional view of a manufacturing apparatus of a battery cell according to an embodiment of the present disclosure.

FIG. 2 is a schematic cross-sectional view of a spare battery cell.

FIG. 3 is a schematic exploded perspective view of an electrode assembly.

FIG. 4 is a schematic operating diagram of a manufacturing apparatus of a battery cell according to an embodiment of the present disclosure.

FIG. 5 is a schematic cross-sectional view of an upper third pressurizing block and a lower third pressurizing block according to an embodiment of the present disclosure.

FIG. 6 is a schematic cross-sectional view of an upper third pressurizing block and a lower third pressurizing block according to another embodiment of the present disclosure.

FIG. 7 is an operating diagram schematically illustrating a state in which a manufacturing apparatus of a battery cell according to an embodiment of the present disclosure is applied to a PPC process.

FIG. 8 is a schematic diagram illustrating a manufacturing method of a battery cell according to an embodiment of the present disclosure.

FIG. 9 is a schematic diagram illustrating a pressurizing operation of a manufacturing method of a battery cell according to an embodiment of the present disclosure.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of each component does not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings.

Hereinafter, an X-axis depicted in the drawings represents a width direction of a battery cell, a Y-axis represents a height direction of the battery cell, and a Z-axis represents a thickness direction of the battery cell. However, these directions are arbitrarily set for ease of understanding, and the aforementioned directions may be changed.

Additionally, a point in which the X-axis, the Y-axis and the Z-axis intersect each other in the attached drawings may be an origin point or a zero point. Any area in the attached drawings may be the origin point or the zero point. If any area or point in the attached drawings is set as the origin or zero point, the X-axis, the Y-axis and the Z-axis depicted in the drawings may maintain the same state as depicted in the drawings with respect to the set origin or zero point. Additionally, the X-axis, the Y-axis and the Z-axis depicted in the attached drawings are depicted in a positive (+) direction, and a negative (-) direction may be understood as an opposite direction to the positive (+) direction based on the origin point or the zero point.

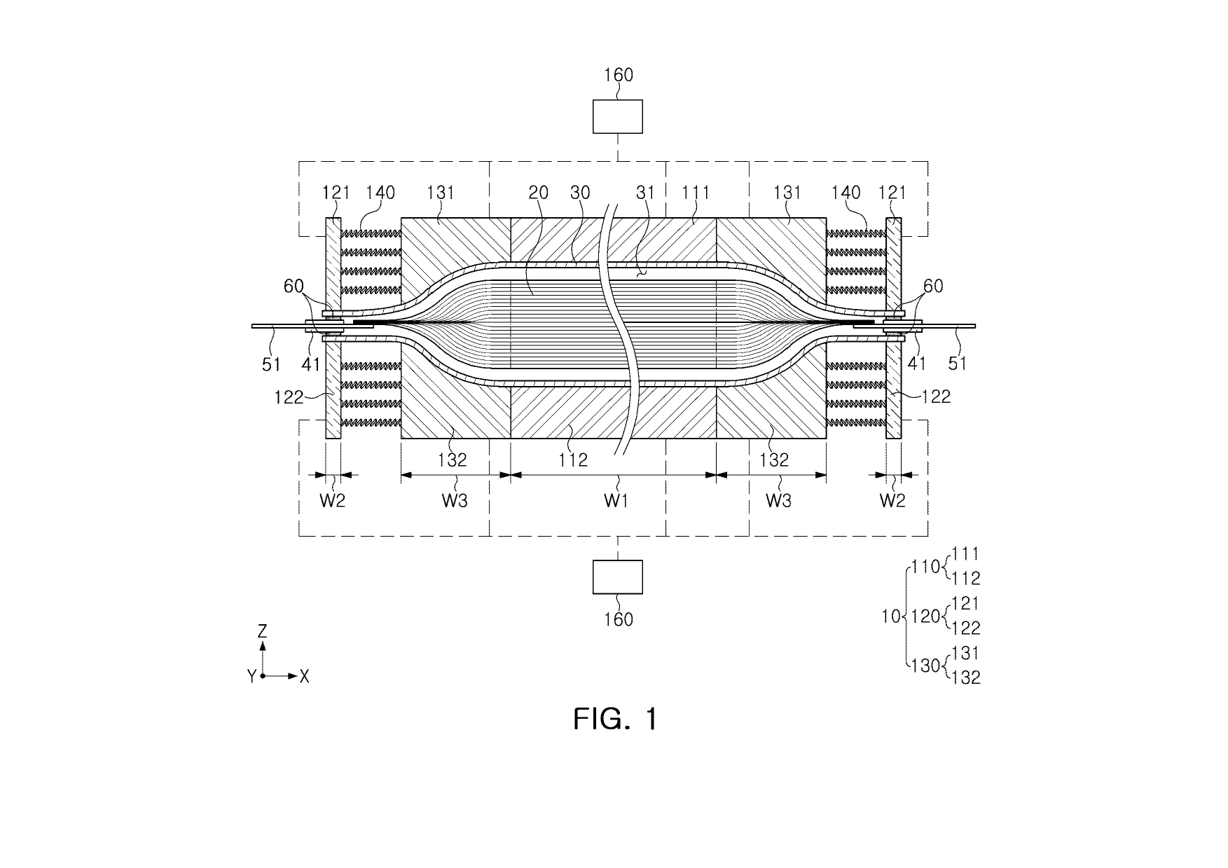

FIG. 1 is a schematic cross-sectional view of a manufacturing apparatus for a battery cell according to an embodiment of the present disclosure, and schematically illustrates a state in which a spare battery cell is mounted in the manufacturing apparatus of a battery cell. In FIG. 1, the spare battery cell is illustrated in cross-section.

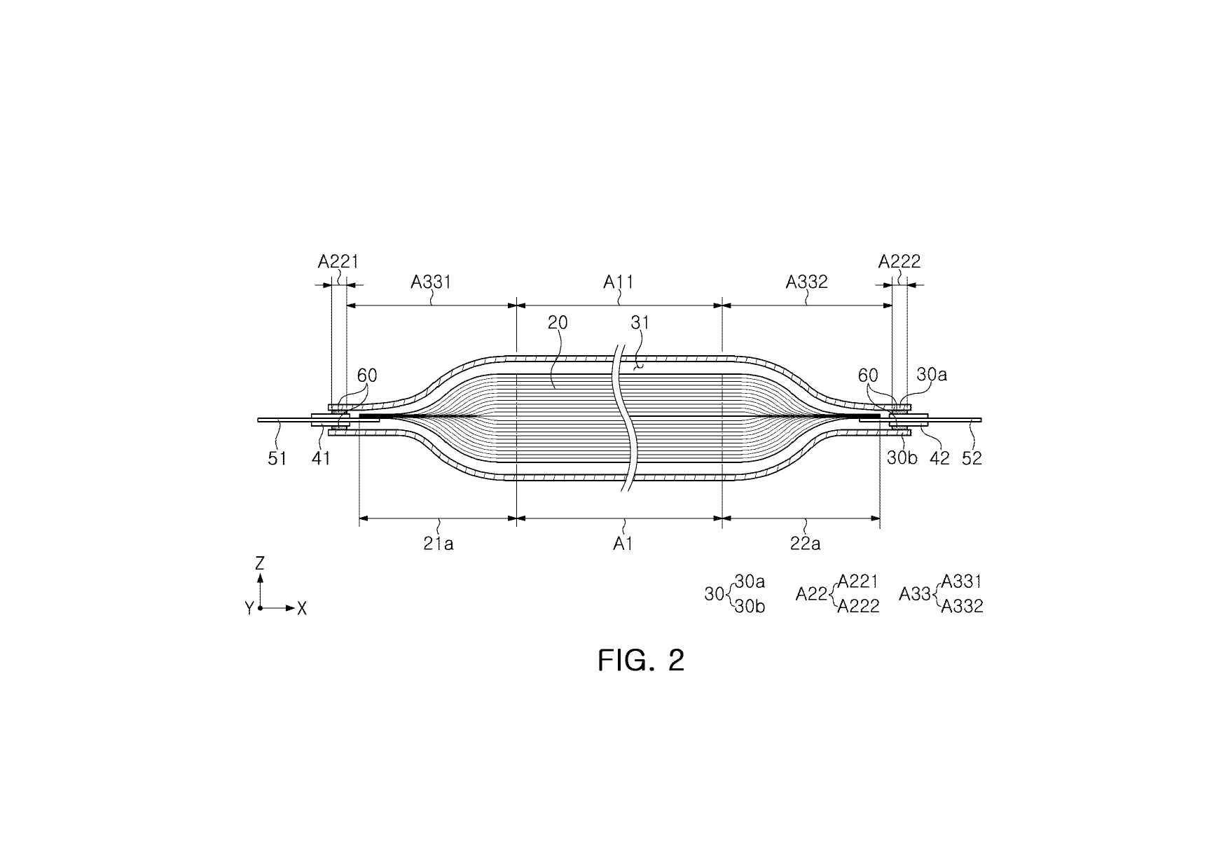

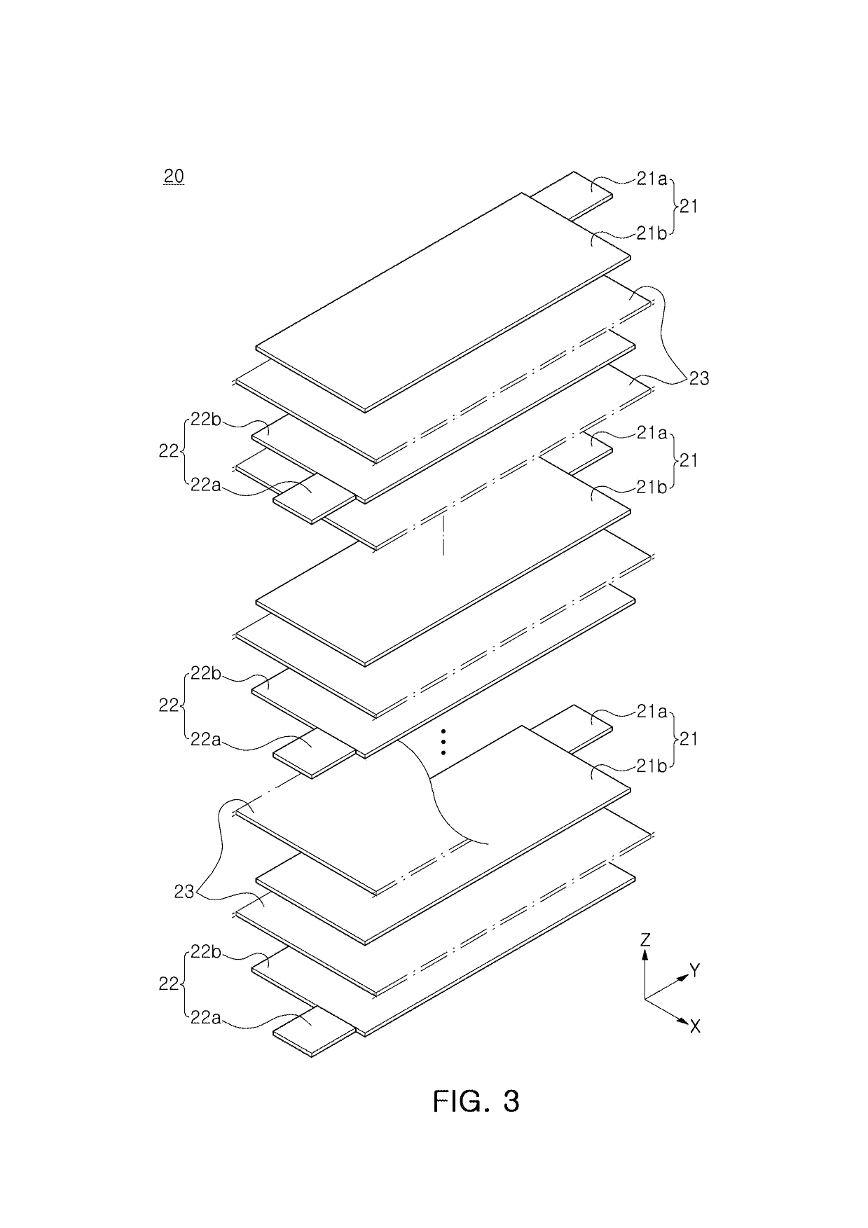

FIG. 2 is a schematic cross-sectional view of the spare battery cell, and FIG. 3 is a schematic exploded perspective view of an electrode assembly 20.

The spare battery cell may have a state in which a gas chamber 70, a space in which gas is accommodated, is not removed in an external material 30. The spare battery cell may include the electrode assembly 20 and an electrolyte within the external material 30, but may have a state in which the gas chamber 70 is not removed. The battery cell may be manufactured by removing the gas chamber 70 from the spare battery cell and completely sealing the external material 30.

The manufacturing apparatus of a battery cell according to the present disclosure may be applied to a spare battery cell from which the gas chamber 70 is not removed. The battery cell described below may be a spare battery cell.

As illustrated in FIGS. 1 to 3, a manufacturing apparatus for a battery cell according to an embodiment of the present disclosure includes a plurality of pressurizing blocks 10 pressurizing an external surface of an external material 30 accommodating an electrode assembly 20 including a cathode plate 21 and an anode plate 22, respectively including an active material region A1 formed by coating an electrode active material and a non-coated region not coated with the electrode active material. The pressurizing blocks 10 may include: a plurality of first pressurizing blocks 110 pressurizing a region corresponding to the active material region A1 in the external material 30; a plurality of second pressurizing blocks 120 pressurizing a region corresponding to a sealing region A22 of the external material 30; and a plurality of third pressurizing blocks 130 interposed between the plurality of first pressurizing blocks 110 and the plurality of second pressurizing blocks 120 and moving in a width direction of the electrode assembly 20.

First, referring to FIGS. 2 and 3, a structure of a battery cell will be described. The battery cell may include an electrode assembly 20 and an electrolyte within the external material 30.

As illustrated in FIG. 3, the electrode assembly 20 may include the cathode plate 21, the anode plate 22 and the separator. The cathode plate 21 and the anode plate 22 may be provided in plural, and the separator may be interposed between the cathode plate 21 and the anode plate 22. The separator may insulate the cathode plate 21 and the anode plate 22 from each other.

The cathode plate 21 may be formed by applying a cathode mixture to at least a partial region of a cathode current collector plate formed of a material including aluminum, stainless steel, nickel, titanium, copper or alloys thereof.

The cathode mixture may be in the form of a slurry in which a cathode active material, a binder, a conductive agent, a dispersant, and the like are mixed and stirred. The cathode mixture may be applied to one surface and the other surface of the cathode current collector, respectively, and then compressed and dried. A region of the cathode plate 21 to which the cathode mixture is applied may be a cathode active material region 21b, and a region to which the cathode mixture is not applied may be a cathode non-coated region 21a.

The anode plate 22 may be formed by applying an anode mixture to at least a partial region of an anode current collector formed of a material including copper, gold, stainless steel, nickel, aluminum, titanium, or alloys thereof.

The anode mixture may be in the form of a slurry in which an anode active material, a binder, a conductive agent, a dispersant, and the like are mixed and stirred. The anode mixture may be applied to one surface and the other surface of the anode current collector, respectively, and then compressed and dried. A region of the anode plate 22 to which the anode mixture is applied may be an anode active material region 22b, and a region thereof to which the anode mixture is not applied may be an anode non-coated region 22a.

When a plurality of cathode plates 21 and a plurality of anode plates 22 are provided, a plurality of cathode non-coated regions 21a may overlap each other, and a plurality of anode non-coated regions 22a may overlap each other. Additionally, a plurality of cathode active material regions 21b may overlap each other, and a plurality of anode active material regions 22b may also overlap each other. However, a separator may be interposed between each cathode plate 21 and each anode plate 22. Accordingly, in the electrode assembly 20, the cathode active material regions 21b and the anode active material regions 22b may overlap each other with the separator interpose therebetween in a thickness direction (Z-direction) of the battery cell. In some cases, the separator may not be disposed between the cathode non-coated regions 21a and the anode non-coated regions 22a in the thickness direction (Z-direction) of the battery cell.

The separator may be disposed on an outermost edge of the electrode assembly 20 in the thickness direction (Z-direction) of the battery cell.

Additionally, the cathode non-coated region 21a formed on the cathode plate 21 may be disposed anywhere on the cathode plate 21, such as on an edge or in a center of the cathode plate 21. The anode non-coated region 22a formed on the anode plate 22 may also be disposed anywhere on the anode plate 22, such as on an edge or in a center of the anode plate 22. A position in which the cathode non-coated region 21a is disposed on the cathode plate 21 and a position in which the anode non-coated region 22a is disposed on the anode plate 22 are not necessarily limited by the present disclosure.

As illustrated in FIG. 2, the electrode assembly 20 may be accommodated inside the external material 30. The external material 30 may has a shape of a film formed by stacking polyethylene terephthalate (PET), nylon and aluminum. Such a battery cell may be a pouch-type secondary battery or a lithium ion battery.

The battery cell may have a first electrode tab 51 and a second electrode tab 52 exposed to the outside of the external material 30. In the battery cell, at least a partial region of the first electrode tab 51 may be exposed on one side of the battery cell, and at least a partial region of the second electrode tab 52 may be exposed on the other side of the battery cell.

The first electrode tab 51 may be welded to the cathode non-coated region 21a of the cathode plate 21, and the second electrode tab 52 may be welded to the anode non-coated region 22a of the anode plate 22. A plurality of first lead films 41 may be provided in a region in which the first electrode tab 51 and the external material 30 face each other, and a plurality of second lead films 42 may be provided in a region in which the second electrode tab 52 and the external material 30 face each other. The first lead film 41 and the second lead film 42 may be formed of an electrically insulating material.

In the battery cell, the external material 30 may be folded so that both ends of the external material 30 are brought into contact with each other, and in a state in which the remaining three corners of the external material 30 overlap each other, a partial region of the overlapping region may be thermally fused except for a corner or a folding line in which a fold line is formed in the external material 30.

In the case of a spare battery cell, only two overlapping corners of the three overlapping corners of the external material 30 may be sealed. Accordingly, the external material 30 of the spare battery cell may be sealed only on the folding line of the external material 30, a corner in which the first electrode tab 51 is withdrawn, and a corner in which the second electrode tab 52 is withdrawn. Accordingly, at least a partial region of the external material 30 of the spare battery cell may be in an open state, and gas may be discharged to an open region of the external material 30.

A position in the external material 30 corresponding to the active material region A1 of the electrode assembly 20 or a region in the external material overlapping the active material region A1 of the electrode assembly 20 in the thickness direction (Z-direction) of the battery cell may be an external material active material region A11. The external material active material region A11 may be pressurized by a plurality of first pressurizing blocks 110.

As illustrated in FIGS. 1 to 3, the manufacturing apparatus of a battery cell may pressurize an external surface of the external material 30. For example, the manufacturing apparatus of a battery cell may be disposed to face the external surface of the external material 30 to pressurize the external material 30.

In an embodiment, an actuator 160 connected to at least one of the plurality of pressurizing blocks 10 and bringing the at least one pressurizing block 10 of the plurality of pressurizing blocks 10 into close contact with the external material 30.

Specifically, the plurality of pressurizing blocks 10 may face the external material 30. The plurality of pressurizing blocks 10 may be connected to the actuator 160 and may be moved in a direction of pressurizing the external surface of the external material 30 and a direction of depressurizing the external surface of the external material 30.

The actuator 160 may be applied to various devices, including robot arms, machining centers, and computer-aided engineering (CAE)-based mechanisms. Additionally, the actuator 160 may be configured as a combination of cylinders, motors, linear structures, or the like. The actuator 160 may be connected to at least one of a control unit, a controller, or a processor of a computer-aided engineering (CAE) device and may be controlled automatically or manually.

The plurality of first pressurizing blocks 110 may pressurize regions corresponding to the cathode active material region 21b and the anode active material region 22b of the external material 30. The plurality of first pressurizing blocks 110 may include an upper first pressurizing block 111 and a lower first pressurizing block 112.

As illustrated in FIG. 2, the external material 30 may be a single film. However, when the external material 30 as the single film is folded and sealed, the external material 30 may be depicted as an upper external material 30a and a lower external material 30b in a thickness-direction cross-section (X-Z plane) of the battery cell in the thickness direction.

Hereinafter, the pressurizing block 10 facing the upper external material 30a and pressurizing the upper external material 30a will be referred to as the upper pressurizing block 10, and the pressurizing block 10 pressurizing the lower external material 30b will be referred to as the lower pressurizing block 10. However, the external material 30 may be a single film, as described above.

Additionally, an external material active material region A1, a sealing region A22 and a terrace region A33 may be in the external material 30 of the battery cell. For example, the outer active material region A1, the sealing region A22 and the terrace region A33 may be disposed on the external surface of the external material 30.

The outer active material region A1 may be a region in which the external material 30 corresponds to the active material region A1 of the electrode assembly 20, and may be a region in which the external material 30 overlaps the active material region A1 of the electrode assembly 20 in the thickness direction (Z-direction) of the battery cell.

The outer active material region A1 may be present in the upper external material 30a and the lower external material 30b.

The sealing region A22 may include a first sealing region A221 and a second sealing region A222. The first sealing region A221 may be a region in which the upper external material 30a and the lower external material 30b are in contact and are thermally welded in a region facing the first electrode tab 51. In this case, a sealant 60 may be provided between the upper external material 30a and one of the first lead films 41, and the sealant 60 may also be provided between the lower external material 30b and another first lead film 41. When the external material 30 is thermally welded, the sealant 60 may be deformed due to heat, thereby sealing the external material 30.

The sealant 60 may be, for example, a material including at least one of thermoplastic resins, polyurethane or silicone. However, the type of sealant 60 is not limited by the present disclosure. The sealant 60 and the external material 30 may be thermally welded, thereby sealing an electrode assembly accommodating space 31 or the external material 30.

In a region in which the first electrode tab 51 is exposed to the outside of the external material 30, one first lead film 41 may be disposed on one surface of the first electrode tab 51, and another first lead film 41 may be disposed on the other surface of the first electrode tab 51. In this case, the other surface of the first electrode tab 51 may be a surface facing one surface of the first electrode tab 51.

Additionally, in a region in which the second electrode tab 52 is exposed to the outside of the external material 30, one second lead film 42 may be disposed on one surface of the second electrode tab 52, and another second lead film 42 may be disposed on the other surface of the second electrode tab 52. In this case, the other surface of the second electrode tab 52 may be a surface facing one surface of the second electrode tab 52.

In an embodiment, the sealant 60 may be disposed between the lead films 41 and 42 and the external material 30, and may be thermally welded, thus bonding the lead films 41 and 42 and the external material 30 or sealing the external material 30. For example, one first lead film 41 may be disposed between the upper external material 30a and one surface of the first electrode tab 51, and another first lead film 41 may be disposed between the lower external material 30b and the other surface of the first electrode tab 51.

Similarly, one second lead film 42 may be disposed between the upper external material 30a and one surface of the second electrode tab 52, and another second lead film 42 may be disposed between the lower external material 30b and the other surface of the second electrode tab 52. In this case, the sealant 60 may be disposed between the lead films 41 and 42 and the upper external material 30a and between the other lead films 41 and 42 and the lower external material 30b.

In the external material 30, the first sealing region A221 may be a region overlapping the sealant 60, at least a portion of one of the first lead films 41 and at least a portion of the first electrode tab 51 in the thickness direction (Z-direction) of the battery cell.

For example, a width of the first sealing region A221 in the width direction (X-direction) of the battery cell may be the same as a width of the sealant 60 in a width direction of the battery cell. In this case, a width of the sealant 60 may be a width after the sealant 60 is thermally deformed.

The second sealing region A222 may be a region overlapping the sealant 60, at least a portion of one of the second lead films 42 and at least a portion of the second electrode tab 52 in the thickness direction (Z-direction) of the battery cell.

A first terrace region A331 may be disposed between the outer active material region A1 and the first sealing region A221 in the external material 30. Additionally, a second terrace region A332 may be disposed between the outer active material region A1 and the second sealing region A222 in the external material 30.

The first terrace region A331 and the second terrace region A332 may not overlap the cathode active material region 21b and the anode active material region 22b in the thickness direction (Z-direction) of the battery cell, and may not face each other. The first terrace region A331 and the second terrace region A332 do not overlap the sealant 60 in the thickness direction (Z-direction) of the battery cell, and may not face each other.

The first terrace region A331 and the second terrace region A332 may face the cathode non-coated region 21a and the anode non-coated region 22a in the thickness direction (Z-direction) of the battery cell, and may overlap each other. The first terrace region A331 and the second terrace region A332 may be a partial region of the external material 30. The first terrace region A331 and the second terrace region A332 may be a partial region of at least one of the upper external material 30a or the lower external material 30b. For example, the first terrace region A331 and the second terrace region A332 may be partial regions of the upper external material 30a and the lower external material 30b.

The upper first pressurizing block 111 may face the external material active material region A1 of the upper external material 30a and may pressurize the external material active material region A1 of the upper external material 30a.

The lower first pressurizing block 112 may face the external material active material region A1 of the lower external material 30b and may pressurize the external material active material region A1 of the lower external material 30b. The upper first pressurizing block 111 and the lower first pressurizing block 112 may be moved in a direction of being close to each other, thus pressurizing the external material 30.

A plurality of second pressurizing blocks 120 may face the first sealing region A221 and the second sealing region A222 and may pressurize the first sealing region A221 and the second sealing region A222.

The plurality of second pressurizing blocks 120 may include a plurality of upper second pressurizing blocks 121. The plurality of upper second pressurizing blocks 121 may include one upper second pressurizing block 121 pressurizing the upper external material 30a in the first sealing region A221 and another upper second pressurizing block 121 pressurizing the upper external material 30a in the second sealing region A222.

The plurality of second pressurizing blocks 120 may include a plurality of lower second pressurizing blocks 122. The plurality of lower second pressurizing blocks 122 may include one lower second pressurizing block 122 pressurizing the lower external material 30b in the first sealing region A221 and another lower second pressurizing block 122 pressurizing the lower external material 30b in the second sealing region A222.

The upper second pressurizing blocks 121 and the lower second pressurizing blocks 122 may be moved in a direction of being close to each other, thus pressurizing the external material 30.

The plurality of upper second pressurizing blocks 121 may face the first sealing region A221 and the second sealing region A222 of the upper external material 30a, respectively. Additionally, the plurality of lower second pressurizing blocks 122 may face the first sealing region A221 and the second sealing region A222 of the lower external material 30b, respectively.

An upper third pressurizing block 131 may be disposed between the upper first pressurizing block 111 and the upper second pressurizing block 121 in the width direction (X-direction) of the battery cell. Additionally, a lower third pressurizing block 132 may be disposed between the lower first pressurizing block 112 and the lower second pressurizing block 122 in the width direction (X-direction) of the battery cell. The upper third pressurizing block 131 and the lower third pressurizing block 132 may be included in the plurality of third pressurizing blocks 130.

A plurality of upper third pressurizing blocks 131 may face the first terrace region A331 and the second terrace region A332 of the upper external material 30a, respectively. Additionally, the plurality of lower third pressurizing blocks 132 may face the first terrace region A331 and the second terrace region A332 of the lower external material 30b, respectively.

The upper third pressurizing blocks 131 and the lower third pressurizing blocks 132 may pressurize the external material 30 in a direction of being close to each other.

For example, the plurality of first pressurizing blocks 110, the plurality of second pressurizing blocks 120 and the plurality of third pressurizing blocks 130 may pressurize an external surface of the external material 30 in the thickness direction (Z-direction) of the external material 30. Accordingly, gas present in the electrode assembly accommodating space 31 may be discharged to the outside of the outer housing 30.

In an embodiment, the actuator 160 may be connected to the upper first pressurizing block 111, the lower second pressurizing block 122, the upper second pressurizing block 121, the lower second pressurizing block 122, the upper third pressurizing block 131 and the lower third pressurizing block 132. The actuator 160 may move the upper first pressurizing block 111 and the lower first pressurizing block 112 in a direction of being close to each other, and may move the upper second pressurizing block 121 and the lower second pressurizing block 122 in a direction of being close to each other, and may move the upper third pressurizing block 131 and the lower third pressurizing block 132 in a direction of being close to each other.

In an embodiment, the strength of the force with which the upper first pressurizing block 111, the lower second pressurizing block 122, the upper second pressurizing block 121, the lower second pressurizing block 122, the upper third pressurizing block 131 and the lower third pressurizing block 132 pressurizes the external material 30 in the thickness direction (Z direction) of the battery cell may be a strength that prevents the first electrode tab 51, the second electrode tab 52 and the external material 30 of the battery cell to be twisted or misaligned with respect to the X-axis. Accordingly, a moment applied to the battery cell may be prevented. This may contribute to improving the quality of the battery cell.

In another embodiment of the present disclosure, the actuator 160 may not be connected to the upper third pressurizing block 131 and the lower third pressurizing block 132. In this case, the upper third pressurizing block 131 and the lower third pressurizing block 132 may be moved by the upper second pressurizing block 121 and the lower second pressurizing block 122.

In an embodiment, in the first terrace region A331, an end of the upper third pressurizing block 131 in an -X-direction may be connected to the upper second pressurizing block 121, and an end of the upper third pressurizing block 131 in an +X-direction may face or contact the upper first pressurizing block 111.

Additionally, in the second terrace region A332, an end of the upper third pressurizing block 131 in the +X-direction may be connected to the upper second pressurizing block 121, and an end of the upper third pressurizing block 131 in the -X-direction may face or contact the upper first pressurizing block 111.

Additionally, in the first terrace region A331, an end of the lower third pressurizing block 132 in the -X-direction may be connected to the lower second pressurizing block 122, and an end of the lower third pressurizing block 132 in the +X-direction may face or contact the lower first pressurizing block 112.

Additionally, in the second terrace region A332, an end of the lower third pressurizing block 132 in the +X-direction may be connected to the lower second pressurizing block 122, and an end of the lower third pressurizing block 132 in the -X-direction may face or contact the lower first pressurizing block 112.

In an embodiment, at least one elastic member 140 may be provided between the plurality of second pressurizing blocks 120 and the plurality of third pressurizing blocks 130.

The plurality of third pressurizing blocks 130 may be connected to a plurality of second pressurizing blocks 120 by elastic members 140, and the plurality of third pressurizing blocks 130 may be supported by the plurality of second pressurizing blocks 120.

In an embodiment, one end of at least one elastic member 140 may be fixed to the second pressurizing block 120, and the other end thereof may be fixed to the third pressurizing block 130.

Additionally, in an embodiment, at least one elastic member 140 may be disposed so that a length thereof is stretched or contracted in a width direction (X-direction) of the electrode assembly 20 or a width direction (X-direction) of the battery cell. Accordingly, at least one elastic member 140 may serve as a buffer when the volume of the external material 30 expands. For example, at least one elastic member 140 may serve as a buffer and backup for the plurality of third pressurizing blocks 130 of the external material 30.

In an embodiment, at least one elastic member 140 may be provided in plural.

For example, the plurality of elastic members 140 may be disposed between the upper second pressurizing block 121 and the upper third pressurizing block 131, and between the lower second pressurizing block 122 and the lower third pressurizing block 132.

Additionally, for example, a plurality of elastic members 140 may be disposed between the upper second pressurizing block 121 and the upper third pressurizing block 131, and a plurality of elastic members 140 may be disposed between the lower second pressurizing block 122 and the lower third pressurizing block 132.

Before deformation of a length of the elastic member 140 occurs, the elastic member 140 may overlap or face the first terrace region A331 in the thickness direction (Z-direction) of the battery cell, and may overlap or face the second terrace region A332 in the thickness direction (Z-direction) of the battery cell.

In an embodiment, the plurality of elastic members 140 may be stacked in the thickness direction (Z-direction) of the electrode assembly 20 or the thickness direction (Z-direction) of the battery cell. Alternatively, the plurality of elastic members 140 may be arranged in the thickness direction (Z-direction) of the electrode assembly 20 or the thickness direction (Z-direction) of the battery cell. For example, the plurality of elastic members 140 may be arranged side by side in the thickness direction (Z-direction) of the electrode assembly 20 or the thickness direction (Z-direction) of the battery cell. Additionally, for example, the plurality of elastic members 140 may be stacked so that at least partial regions of the elastic members overlap each other in the thickness direction (Z-direction) of the electrode assembly 20 or the thickness direction (Z-direction) of the battery cell.

Additionally, for example, the plurality of elastic members 140 may be disposed between the upper second pressurizing block 121 and the upper third pressurizing block 131 in a position corresponding to the first terrace region A331 of the upper exterior member 30a.

In this case, the plurality of elastic members 140 may be arranged side by side in the thickness direction of the battery cell or the thickness direction of the electrode assembly 20. Accordingly, the plurality of elastic members 140 may overlap each other in the thickness direction of the battery cell or the thickness direction of the electrode assembly 20.

Additionally, the plurality of elastic members 140 may be stretched or contracted in the same direction.

FIG. 1 illustrates a state in which volume expansion of a battery cell does not occur before a plurality of elastic members 140 are deformed in length. The volume expansion of the battery cell may be caused by gas present in the electrode assembly accommodating space 31.

For example, gas may be generated in the electrode assembly accommodating space 31 when voltage or power is applied to the battery cell.

As illustrated in FIGS. 1 and 2, in an embodiment of the present disclosure, in a state in which the volume expansion of the battery cells has not occurred before longitudinal deformation of the plurality of elastic members 140 occurs, a width W1 of the plurality of first pressurizing blocks 110 in a thickness-direction cross-section (X-Z plane) of the external material 30 may be a value equal to 0.9 times or more and 1.1 times or less of a width of the active material region A1 in a width direction (X-direction) of the battery cell. Additionally, a width W2 of the plurality of second pressurizing blocks 120 in the thickness-direction cross-section (X-Z plane) of the external material 30 may be a value equal to 0.9 times or more and 1.1 times or less of a width of the sealing region A22 in the width direction (X-direction) of the battery cell.

Accordingly, the pressurization efficiency of the active material region A1 and the sealing region A22 may be increased.

Additionally, in an embodiment, the width W1 of the plurality of first pressurizing blocks 110 in the thickness-direction cross-section (X-Z plane) of the external material 30 may be the same as the width of the active material region A1 in the width direction (X-direction) of the battery cell. Additionally, the width W2 of the plurality of second pressurizing blocks 120 in the thickness-direction cross-section (X-Z plane) of the external material 30 may be the same as the width of the sealing region A22 in the width direction (X-direction) of the battery cell

The width W1 of the upper first pressurizing block 111 and the width W1 of the lower first pressurizing block 112 may be the same, and the width W2 of the upper second pressurizing block 112 and the width W2 of the lower second pressurizing block 122 may be the same.

Here, the plurality of first pressurizing blocks 110 may refer to an upper first pressurizing block 111 and a lower second pressurizing block 122, and the plurality of second pressurizing blocks 120 may refer to a plurality of upper second pressurizing blocks 121 and a plurality of lower second pressurizing blocks 122.

A width W3 of the plurality of third pressurizing blocks 130 in the width direction (X-direction) of the battery cell may be a value equal to 0.9 times or more and 1.1 times or less of the width of the terrace region A33 in the width direction (X-direction) of the battery cell.

Additionally, in an embodiment, the width W3 of the battery cells of the plurality of third pressurizing blocks 130 in the width direction (X-direction) may be equal to the width of the terrace region A33 in the width direction (X-direction) of the battery cell.

For example, in the first terrace region A331, the width W3 of the upper third pressurizing block 131 and the width W3 of the lower third pressurizing block 132 may be equal to each other, and the width W3 of the upper third pressurizing block 131 and the width W3 of the lower third pressurizing block 132 may be equal to the width of the first terrace region A331 in the width direction (X-direction) of the battery cell.

Additionally, in the second terrace region A332, the width W3 of the upper third pressurizing block 131 and the width W3 of the lower third pressurizing block 132 may be equal to the width of the second terrace region A332 in the width direction (X-direction) of the battery cell.

Accordingly, the first terrace region A331 and the second terrace region A332 may be pressurized in the thickness direction (Z-direction) of the battery cell or the thickness direction (Z-direction) of the external material 30 by the plurality of third pressurizing blocks 130.

When the actuator 160 is connected to the plurality of third pressurizing blocks 130, the first terrace region A331 and the second terrace region A332 may be pressurized in the +Z-direction and the -Z-direction by force provided by the actuator 160 and a weight of the plurality of third pressurizing blocks 130.

On the other hand, when the actuator 160 is not connected to the plurality of third pressurizing blocks 130, the first terrace region A331 and the second terrace region A332 may be pressurized in the +Z-direction and the -Z-direction by the weight of the plurality of third pressurizing blocks 130.

In addition, the first terrace region A331 and the second terrace region A332 may also be pressurized in the width direction (X-direction) of the battery cell by a plurality of third pressurizing blocks 130.

In the first terrace region A331, the upper third pressurizing block 131 and the lower third pressurizing block 132 may pressurize the upper external material 30a and the lower external material 30b in the thickness direction (Z-direction) of the battery cell and the width direction (X-direction) of the battery cell. In this case, in the first terrace region A331, the upper third pressurizing block 131 and the lower third pressurizing block 132 may pressurize the upper external material 30a and the lower external material 30b in the +X-direction.

In the second terrace region A332, the upper third pressurizing block 131 and the lower third pressurizing block 132 may pressurize the upper external material 30a and the lower external material 30b in the thickness direction (Z-direction) and the width direction (X-direction) of the battery cell. In this case, in the second terrace region A332, the upper third pressurizing block 131 and the lower third pressurizing block 132 may pressurize the upper external material 30a and the lower external material 30b in the -X-direction.

Accordingly, the upper external material 30a and the lower external material 30b may be prevented from separating from each other in the first terrace region A331 and the second terrace region A332 due to gas generated in the electrode assembly accommodating space 31.

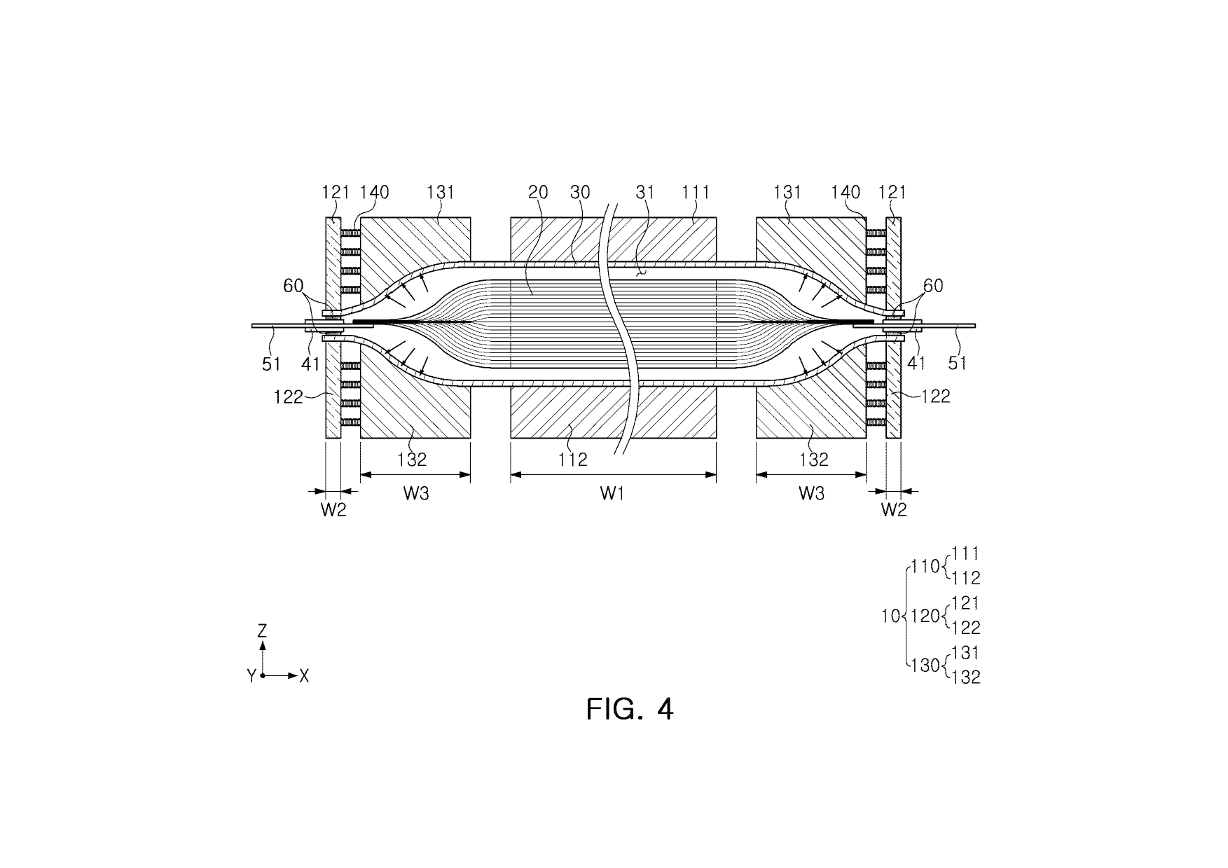

FIG. 4 is a schematic diagram of an operating state of a manufacturing apparatus for a battery cell according to an embodiment of the present disclosure. The manufacturing apparatus of a battery cell and the spare battery cell are illustrated in cross-section. The battery cell referred to below may be a spare battery cell.

As illustrated in FIGS. 2 and 4, when voltage is applied to the battery cell through the first electrode tab 51 and the second electrode tab 52 of the battery cell, a volume of the external material 30 may expand due to gas generated in the electrode assembly accommodating space 31.

The volume expansion of the external material 30 may occur in the thickness direction (Z-direction) of the battery cell and the width direction (X-direction) of the battery cell.

In this case, the plurality of third pressurizing blocks 130 may pressurize the external material 30 in the first terrace region A331 and the second terrace region A332 in the thickness direction (Z-direction) of the battery cell and the width direction (X-direction) of the battery cell, so that gas generated in the electrode assembly accommodating space 31 does not separate the upper external material 30a and the lower external material 30b. Accordingly, the external material 30 may be prevented from being prematurely vented or unsealed in a position in which the first electrode tab 51 and the second electrode tab 52 are disposed. Accordingly, a press pre-charge (PPC) process of the battery cell may be easily performed, and premature venting or unsealing of the external material 30 during the press pre-charge (PPC) process of the battery cell may be prevented. Accordingly, the quality of the battery cell may be improved.

For example, as illustrated in FIG. 4, when the volume of the external material 30 expands in the width direction (X-direction) of the battery cell, the elastic member 140 may absorb the volume expansion of the external material 30.

That is, the elastic member 140 may be shrink in length by the amount of volume expansion of the external material 30 in the width direction (X-direction) of the battery cell. A length contraction of the elastic member 140 may occur when a plurality of third pressurizing blocks 130 pressurize the elastic member 140. The plurality of third pressurizing blocks 130 may pressurize the elastic member 140 by causing gas present in the electrode assembly accommodating space 31 to expand the external material 30.

In an embodiment, the elastic member 140 may be formed of a material including at least one of a polymer, urethane or rubber. Accordingly, the strength of reaction force against the expansion of the external material 30 in the width direction (X-direction) of the battery cell may be determined by the elastic modulus of the elastic member 140.

Additionally, in an embodiment, the elastic member 140 may be a spring. Additionally, as an example, the elastic member 140 may be a compression spring. In an embodiment, the material of the elastic member 140 may be a material including silicone.

In an embodiment, to increase the strength of the reaction force or repulsion of the elastic member 140 and the plurality of third pressurizing blocks 130 against the expansion of the external material 30 in the width direction (X-direction) of the battery cells, a spring constant may be relatively increased. Accordingly, even if the external material 30 expands in the width direction (X-direction) of the battery cells, the longitudinal contraction of the elastic member 140 may be minimized, and the movement of the plurality of third pressurizing blocks 130 in the width direction of the battery cells may also be minimized.

In this case, the expansion of the external material 30 in the width direction (X-direction) of the battery cell may be minimized, and the movement of gas present in a demand space of the electrode assembly 20 toward the first sealing region A221, the second sealing region A222, the first terrace region A331 and the second terrace region A332 may be minimized.

Accordingly, depending on the characteristics of the electrode active material, when the amount of gas generated in the electrode assembly accommodating space 31 is relatively large, an elastic member 140 having a relatively large spring constant may be applied, and when the amount of gas generated in the electrode assembly accommodating space 31 is relatively small, an elastic member 140 having a relatively small spring constant may be applied.

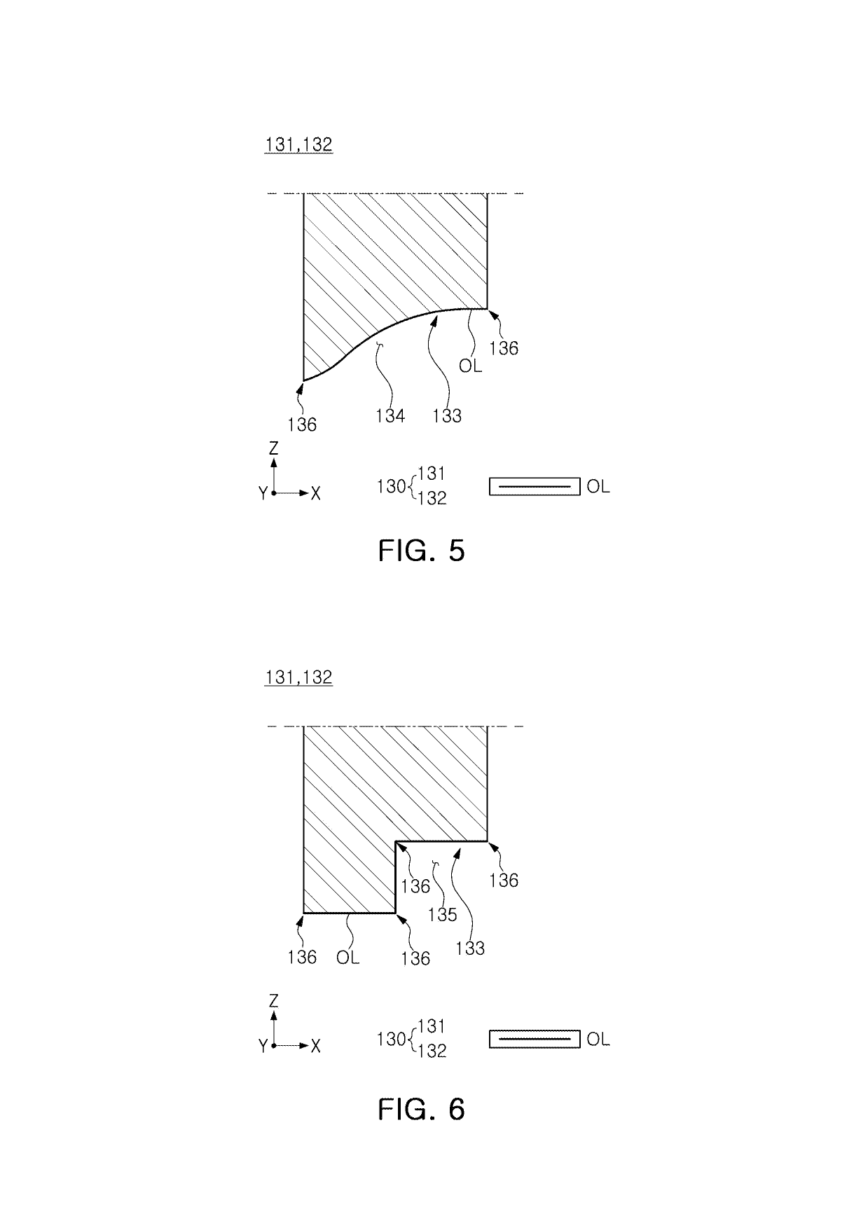

FIG. 5 schematically illustrates cross-sections of an upper third pressurizing block 131 and a lower third pressurizing block 132 according to an embodiment of the present disclosure. When the third pressurizing block 130 illustrated in FIG. 5 is the lower third pressurizing block 132, it should be understood that the lower third pressurizing block 132 rotates in the Z-axis direction with the X-axis as the rotational axis. That is, when the third pressurizing block 130 illustrated in FIG. 5 is the lower third pressurizing block 132, an image illustrated in FIG. 5 may be understood as being inverted downwards based on the X-axis. Additionally, when the third pressurizing block 130 illustrated in FIG. 5 is the third pressurizing block 130 provided in the second terrace region A332, the image illustrated in FIG. 5 may be understood as being inverted rightward based on the Z-axis. Additionally, when the image illustrated in FIG. 5 is the lower third pressurizing block 132 provided in the second terrace region A332, the image illustrated in FIG. 5 should be understood as being rotated in the Z-axis direction using the X-axis as a rotation axis, and also inverted rightward based on the Z-axis.

As illustrated in FIGS. 4 and 5, in an embodiment of the present disclosure, the plurality of third pressurizing blocks 130 may include a notch 134 on a surface 133 in contact with the external material 30.

For example, in a thickness direction cross-section (X-Z plane) of the external material 30 of the plurality of third pressurizing blocks 130, an outer contour line OL of the surface 133 on which the plurality of third pressurizing blocks 130 are in contact with the external material 30 may include a curved line.

Additionally, the surface 133 on which the plurality of third pressurizing blocks 130 are in contact with the external material 30 may include a recessed region.

Additionally, in an embodiment, the outer contour line OL of the surface 133 on which the plurality of third pressurizing blocks 130 are in contact with the external material 30 in the thickness-direction cross-section (X-Z plane) of the external material 30 may have a shape corresponding to an outer contour line of the external material 30.

Additionally, when the outer contour line OL of the surface 133 on which the plurality of third pressurizing blocks 130 are in contact with the external material 30 includes a curved line, a curvature of the outer contour line OL may correspond to or may be identical to a curvature of the outer contour line of the external material 30.

That is, the surface 133 on which the plurality of third pressurizing blocks 130 are in contact with the external material 30 may be in close contact with the external material 30. In this case, the surface 133 on which the plurality of third pressurizing blocks 130 are in contact with the external material 30 may be in close contact with the external material 30 before volume expansion occurs. Accordingly, the outer contour line OL of the surface 133 on which the plurality of third pressurizing blocks 130 are in contact with the external material 30 may correspond to or may be identical to the outer contour line of the external material 30 before volume expansion occurs. Accordingly, a contact area between the external material 30 and the plurality of third pressurizing blocks 130 may increase, and volume expansion of the external material 30 may be effectively suppressed.

Additionally, in an embodiment, the upper third pressurizing block 131 and the lower third pressurizing block 132 or the plurality of third pressurizing blocks 130 may include a curved line (R value) on a corner 136 in the thickness direction cross-section (X-Z plane) of the upper third pressurizing block 131 and the lower third pressurizing block 132 or the plurality of third pressurizing blocks 130. The curved line formed on the corner 136 may be a rounded region of the upper third pressurizing block 131, the lower third pressurizing block 132, or a plurality of third pressurizing blocks 130.

FIG. 6 schematically illustrates a cross-section of the upper third pressurizing block 131 and the lower third pressurizing block 132 according to another embodiment of the present disclosure, and is illustrated using the same principle as FIG. 5. Accordingly, the upper third pressurizing block 131 and the lower third pressurizing block 132 illustrated in FIG. 6 may also be understood using the same principle as FIG. 5.

As illustrated in FIG. 6, in an embodiment of the present disclosure, the plurality of third pressurizing blocks 130 may include a groove 135 on the surface 133 in contact with the external material 30. For example, the upper third pressurizing block 131 and the lower third pressurizing block 132 may include a groove 135 on the surface 133 in contact with the external material 30.

In an embodiment, the upper third pressurizing block 131 and the lower third pressurizing block 132 or the plurality of pressurizing blocks 130 may include a curved line (R value) on the corner 136 in the thickness direction cross-section (X-Z plane) of the upper third pressurizing block 131 and the lower third pressurizing block 132 or the plurality of pressurizing blocks 130. The curved line formed on the corner 136 may be a rounding region of the upper third pressurizing block 131 and the lower third pressurizing block 132 or the plurality of third pressurizing blocks 130. The corner 136 may be provided in plural, and at least one of the corners 136 may have a curved line or a rounding region. Additionally, the outer contour line OL of the surface 133 on which the upper third pressurizing block 131 and the lower third pressurizing block 132 are in contact with the external material 30 may include a plurality of straight lines. In this case, when at least one curved line is formed on the corner 136, at least one curved line and at least one straight line may be connected to each other. Additionally, the plurality of straight lines may be connected to each other. This principle may be applied to a case illustrated in FIG. 5.

At least a portion of the outer contour lines OL of the upper third pressurizing block 131 and the lower third pressurizing block 132 may be in non-contact with the external material 30. In this case, volume expansion of the external material 30 may be permitted to a certain extent. Accordingly, based on the specifications of the battery cell, or the like., the shape of the outer line OL of the surface 133 on which the upper third pressurizing block 131 and the lower third pressurizing block 132 or the plurality of third pressurizing blocks 130 are in contact with the external material 30 may be appropriately selected.

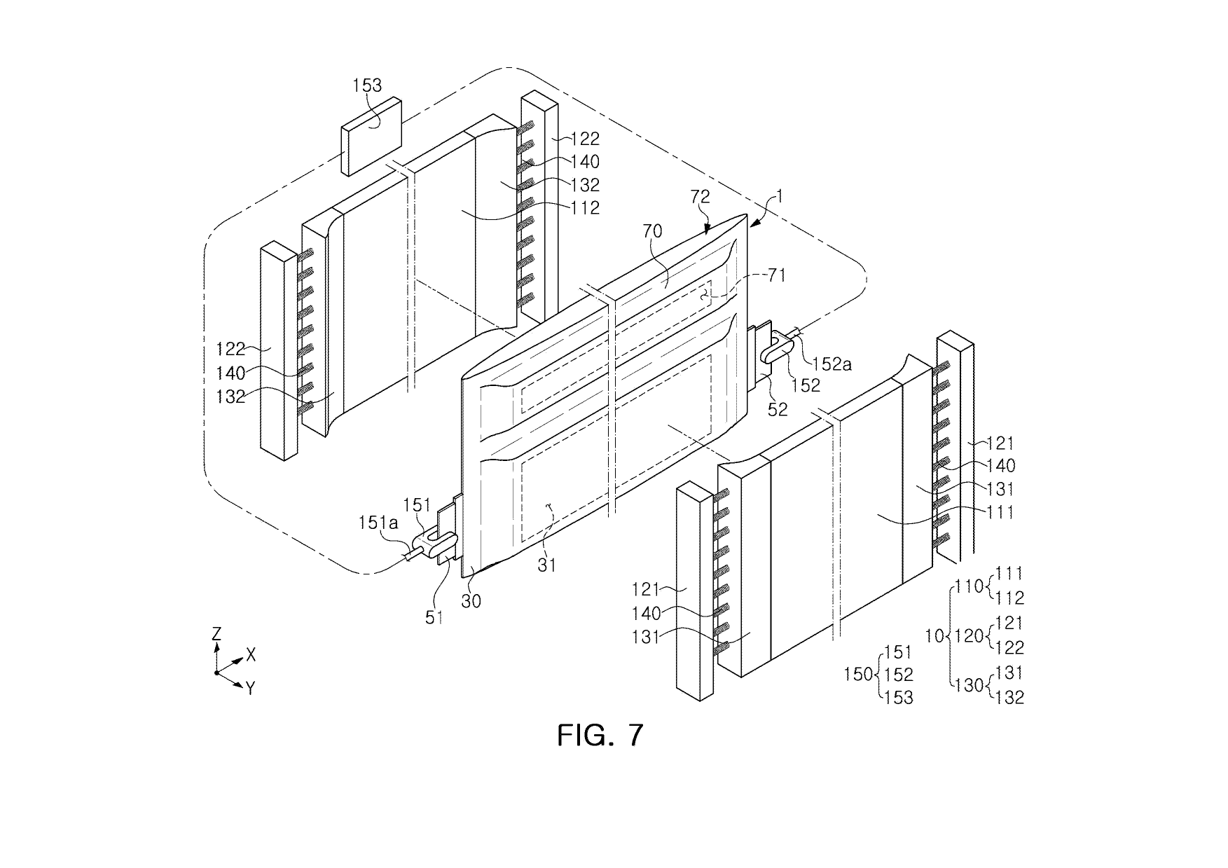

FIG. 7 is an operational diagram schematically illustrating a state in which a manufacturing apparatus for a battery cell according to an embodiment of the present disclosure is applied to a PPC process.

As illustrated in FIG. 7, the manufacturing apparatus of a battery cell according to an embodiment of the present disclosure may further include a voltage supply unit 150 connected to the cathode plate 21 and the anode plate 22 to apply voltage.

The voltage supply unit 150 may apply voltage to a spare battery cell 1. The spare battery cell 1 may be provided with an electrode assembly accommodating space 31 and a gas chamber 70 in the external material 30. The gas chamber 70 may be formed in the external material 30 and may include a gas accommodating space 71 connected to the electrode assembly accommodating space 31. Accordingly, gas generated in the electrode assembly accommodating space 31 may be moved to the gas accommodating space 71.

In the spare battery cell 1, at least a partial region of the external material 30 may be open, and the external material 30 of the spare battery cell 1 may include an open region 72. The open region 72 may serve as a passage through which the gas accommodated by the gas accommodating space 71 is moved to the outside of the external material 30. The electrode assembly accommodating space 31 may be provided with an electrolyte together with the electrode assembly 20.

In a subsequent process, the gas chamber 70 may be removed from the external material 30. Once the gas chamber 70 is removed from the spare battery cell 1 and the external material 30 is completely sealed, the spare battery cell 1 may become a final battery cell.

As illustrated in FIGS. 4 and 7, in an embodiment of the present disclosure, the voltage supply unit 150 may include a first grounding member 151 connected to the first electrode tab 51, a second grounding member 152 connected to the second electrode tab 52, and a power supply unit 153 connected to the first grounding member 151 and the second grounding member 152.

The first grounding member 151 and the second grounding member 152 may be formed of an electrically conductive material. Additionally, the first grounding member 151 may be connected to a first connection portion of the power supply unit 153 via a first line 151a, and the second grounding member 152 may be connected to a second connection portion of the power supply unit 153 via a second line 152a. The first connection portion and the second connection portion may have different electrical polarities.

The spare battery cell 1 may have a state in which the first electrode tab 51 and the second electrode tab 52 are fixed by the first grounding member 151 and the second grounding member 152.

The power supply unit 153 may be a power supply, and a type thereof is not necessarily limited by the present disclosure.

In a state in which the plurality of pressurizing blocks 10 pressurizes the external material 30, voltage may be applied to the spare battery cell 1 by the power supply unit 153. Then, gas may be generated in the electrode assembly accommodating space 31, and the volume of the external material 30 may expand due to the gas.

In this case, since the plurality of pressurizing blocks 10 pressurize the external material 30, the gas may move to the gas chamber 70, and the movement of the gas to the first terrace region A331, the second terrace region A332, the first sealing region A221 and the second sealing region A222 may be suppressed. Accordingly, the gas may move only to the gas chamber 70 and the open region 72 of the external material 30. Accordingly, the present disclosure may prevent the external material 30 from being prematurely vented or unsealed in a position in which the first electrode tab 51 and the second electrode tab 52 exist.

Additionally, in some cases, when the gas pressure is significantly high and the external material 30 expands in the width direction (X-direction) of the battery cell, the plurality of third pressurizing blocks 130 may pressurize the external material 30 in the width direction (X-direction) of the battery cell, thereby suppressing excessive expansion of the external material 30 in the width direction (X-direction) of the battery cell. In this case, the plurality of third pressurizing blocks 130 may also pressurize the external material 30 in the thickness direction (Z-direction) of the battery cell.

When the external material 30 expands in the width direction (X-direction) of the battery cell, a length of the elastic member 140 in the width direction (X-direction) of the battery cell may be contracted. The elastic member 140 may reduce damage or injury to the external material 30 when the electrode assembly accommodating space 31 is filled with gas.

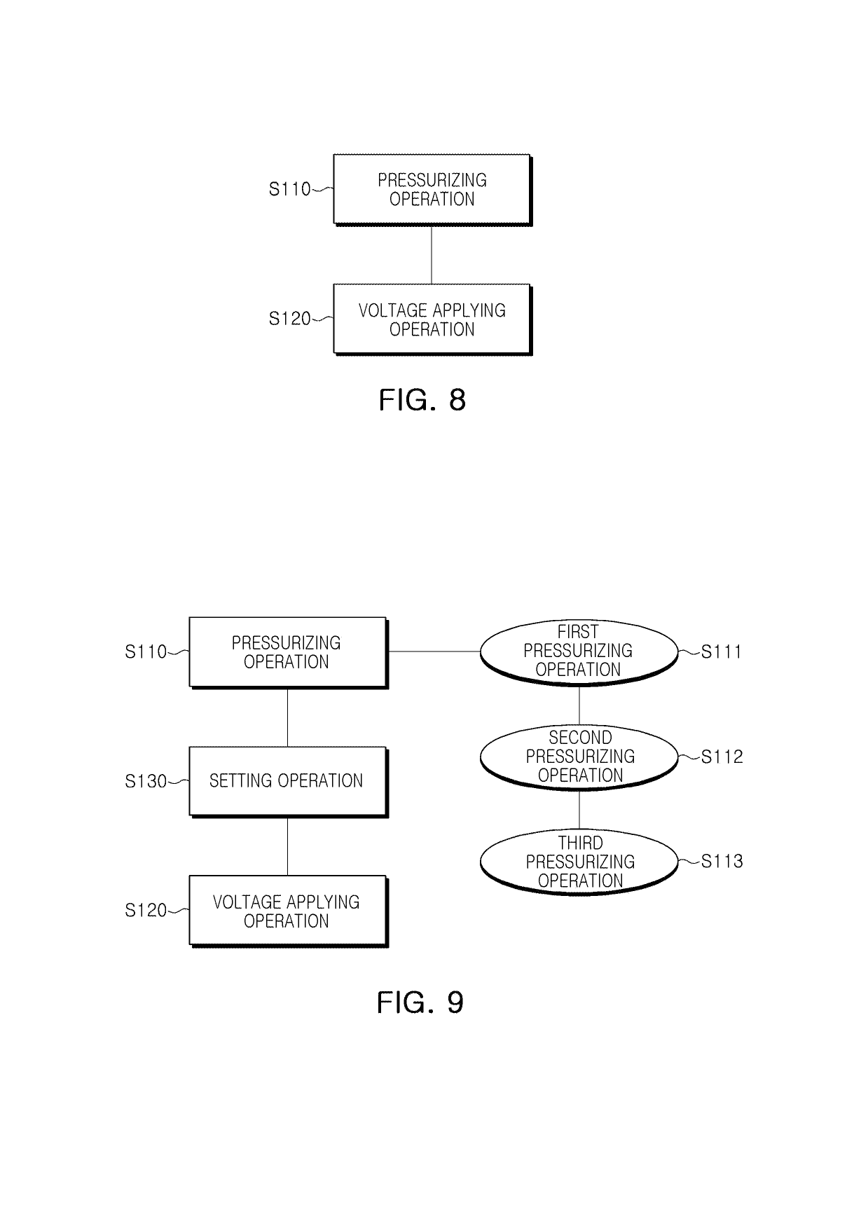

Meanwhile, as another aspect, the present disclosure provides a manufacturing method for a battery cell. FIG. 8 schematically illustrates a manufacturing method for a battery cell according to an embodiment of the present disclosure.

As illustrated in FIGS. 1 to 8, in an embodiment of the present disclosure, provided is a manufacturing method for a battery cell of manufacturing a battery cell by pressurizing an external surface of an external material 30 accommodating an electrode assembly 20 including a cathode plate 21 and an anode plate 22, respectively including an active material region A1 formed by coating an electrode active material and a non-coated region not coated with the electrode active material, the method including a pressurizing operation (S110) of pressurizing the external material 30 using a plurality of pressurizing blocks 10, and a voltage applying operation (S120) of applying a voltage to the cathode plate 21 and the anode plate 22.

The battery cell may be a battery cell according to at least one of the above-described embodiments. Alternatively, the battery cell may be another battery cell in which an electrode assembly 20 and an electrolyte are accommodated in an external material 30.

The active material region A1 may include a cathode active material region 21b and an anode active material region 22b. The non-coated region may include a cathode non-coated region 21a and an anode non-coated region 22a.

The voltage applying operation (S120) may be performed by connecting a power supply unit 153 to each of the cathode plate 21 and the anode plate 22 to apply voltage to the battery cell.

FIG. 9 schematically illustrates the pressurizing operation (S110) of a manufacturing method for a battery cell according to an embodiment of the present disclosure.

As illustrated in FIGS. 1 to 9, in an embodiment of the present disclosure, the pressurizing operation (S110) may include: pressurizing a first region, a region corresponding to the active material region A1 in the external material 30, with a plurality of first pressurizing blocks 110; pressurizing a second region, a region corresponding to the sealing region A22 in the external material 30, with a plurality of second pressurizing blocks 120; and pressurizing a terrace region A33 disposed between the sealing region A22 and the active material region A1 of the external material 30 with a plurality of third pressurizing blocks 130.

For example, the pressurizing operation (S110) may include: a first pressurizing operation (S111) of pressurizing a first region, a region corresponding to the active material region A1 in the external material 30, with a plurality of first pressurizing blocks 110; a second pressurizing operation (S112) of pressurizing a second region, a region corresponding to the sealing region A22 in the external material 30, with a plurality of second pressurizing blocks 120; and a third pressurizing operation (S113) of pressurizing a terrace region A33 disposed between the sealing region A22 and the active material region A1 of the external material 30 with a plurality of third pressurizing blocks 130.

The first pressurizing operation (S111), the second pressurizing operation (S112) and the third pressurizing operation (S113) may be performed simultaneously.

Additionally, in an embodiment, the first pressurizing operation (S111), the second pressurizing operation (S112) and the third pressurizing operation (S113) may be performed at different times or may be performed sequentially.

The first pressurizing operation (S111), the second pressurizing operation (S112) and the third pressurizing operation (S113) may be performed before gas is present in the electrode assembly accommodating space 31 of the external material 30, and the first pressurizing operation (S111), the second pressurizing operation (S112) and the third pressurizing operation (S113) may be performed even while gas is generated in the electrode assembly accommodating space 31 of the external material 30.

The first pressurizing operation (S111), the second pressurizing operation (S112) and the third pressurizing operation (S113) may be performed by moving a plurality of first pressurizing blocks 110, a plurality of second pressurizing blocks 120 and a plurality of third pressurizing blocks 130 using an actuator 160.

In this case, depending on the case, the actuator 160 may not move the plurality of third pressurizing blocks 130. That is, the actuator 160 may not be connected to the plurality of third pressurizing blocks 130.

In an embodiment, the manufacturing method for a battery cell may further include a setting operation (S130) of determining an elastic modulus of the elastic member 140 connecting the plurality of second pressurizing blocks 120 and the plurality of third pressurizing blocks 130. The setting operation (S130) may determine the elastic modulus of the elastic member 140 based on a silicon content of the electrode active material.

In an embodiment, in the setting operation (S130), depending on the characteristics of the electrode active material applied to the electrode assembly 20 accommodated in the outer housing 30, when the amount of gas generated in the electrode assembly accommodating space 31 is relatively large, an elastic member 140 having a relatively large spring constant or elastic modulus may be applied, and when the amount of gas generated in the electrode assembly accommodating space 31 is relatively small, an elastic member 140 having a relatively small spring constant or elastic modulus may be applied.

Additionally, in an embodiment, the setting operation (S130) may determine the elastic modulus or spring constant so that the silicon content of the electrode active material is proportional to the elastic modulus or spring constant.

The electrode active material may include an anode mixture. The anode mixture may include an anode active material.

For example, as the silicon content in the anode mixture applied to the anode active material region 22b increases, the amount of gas generated in the electrode assembly accommodating space 31 may increase.

Accordingly, as the silicon content in the anode active material increases, the elastic member 140 having a high elastic modulus or spring constant may be applied, and as the silicon content in the anode active material decreases, the elastic member 140 having a low elastic modulus or spring constant may be applied.

The silicon content in the anode active material or the anode mixture may be a mass of silicon within a mass of the anode active material or a mass of the anode mixture. A composition of the anode mixture or the anode active material may be expressed as a fraction (%). In the silicon content, may refer to a content of silicon included in the anode mixture or the anode active material, expressed as a fraction (%). For example, the silicon content may refer to the mass of silicon within the mass of the anode mixture or the mass of the anode active material.

For example, when the silicon content in the anode active material is less than 1%, a low-load elastic member 140 may be applied, and when the silicon content is 1% or more but less than 5%, a middle-load elastic member 140 may be applied, and when the silicon content is 5% or more, a high-load elastic member 140 may be applied.

Additionally, the aforementioned low-load elastic member may be referred to as a low-strength elastic member, the medium-load elastic member may be referred to as a middle-strength elastic member, and the high-load elastic member may be referred to as a high-strength elastic member.

The elastic member 140 may be a compression spring, but the type of elastic member 140 is not necessarily limited by the present disclosure.

The above-described content is merely an example of the application of the principles of the present disclosure. Other components may be included or substituted without departing from the scope of the present disclosure. Additionally, the above-described embodiments may be substituted or combined with each other.

What is claimed is:

1. A manufacturing apparatus for a battery cell, comprising:
a plurality of pressurizing blocks pressurizing an external surface of an external material accommodating an electrode assembly including a cathode plate and an anode plate, respectively including an active material region formed by coating an electrode active material and a non-coated region not coated with the electrode active material,
wherein the plurality of pressurizing blocks include:
a plurality of first pressurizing blocks pressurizing a region corresponding to the active material region in the external material;
a plurality of second pressurizing blocks pressurizing a region corresponding to a sealing region of the external material; and
a plurality of third pressurizing blocks interposed between the plurality of first pressurizing blocks and the plurality of second pressurizing blocks and moving in a width direction of the electrode assembly.

2. The manufacturing apparatus for a battery cell of claim 1, further comprising:
at least one elastic member disposed between the plurality of second pressurizing blocks and the plurality of third pressurizing blocks.

3. The manufacturing apparatus for a battery cell of claim 2, wherein the at least one elastic member is provided in plural.

4. The manufacturing apparatus for a battery cell of claim 2, wherein the at least one elastic member is stretched or contracted in a width direction of the electrode assembly.

5. The manufacturing apparatus for a battery cell of claim 1, wherein the plurality of third pressurizing blocks include a notch or a groove on a surface in contact with the external material.

6. The manufacturing apparatus for a battery cell of claim 3, wherein the plurality of elastic members are stacked in a thickness direction of the electrode assembly.

7. The manufacturing apparatus for a battery cell of claim 1, further comprising:
an actuator connected to at least one pressurizing block of the plurality of pressurizing blocks, and bringing the at least one pressurizing block of the plurality of pressurizing blocks into close contact with the external material.

8. The manufacturing apparatus for a battery cell of claim 1, wherein the plurality of first pressurizing blocks, the plurality of second pressurizing blocks and the plurality of third pressurizing blocks pressurize an external surface of the external material in a thickness direction of the external material.

9. The manufacturing apparatus for a battery cell of claim 1, wherein a width of the plurality of first pressurizing blocks in a thickness direction cross-section of the external material is a value equal to 0.9 times or more and 1.1 times or less of a width of the active material region, and
a width of the plurality of second pressurizing blocks in the thickness direction cross-section of the external material is a value equal to 0.9 times or more and 1.1 times or less of a width of the sealing region.

10. The manufacturing apparatus for a battery cell of claim 2, wherein the at least one elastic member includes a material including at least one of polymer, urethane or rubber.

11. The manufacturing apparatus for a battery cell of claim 1, further comprising:
a voltage supply unit connected to the cathode plate and the anode plate and applying voltage.

12. A manufacturing method for a battery cell of manufacturing a battery cell by pressurizing an external surface of an external material accommodating an electrode assembly including a cathode plate and an anode plate, respectively including an active material region formed by coating an electrode active material and a non-coated region not coated with the electrode active material, the method comprising:
a pressurizing operation of pressurizing the external material with a plurality of pressurizing blocks; and
a voltage applying operation of applying voltage to the cathode plate and the anode plate.

13. The manufacturing method for a battery cell of claim 12, wherein the pressurizing operation includes:
pressurizing a first region, a region corresponding to the active material region in the external material, with a plurality of first pressurizing blocks;
pressurizing a second region, a region corresponding to a sealing region in the external material, with a plurality of second pressurizing blocks; and
pressurizing a terrace region disposed between the sealing region and the active material region in the external material, with a plurality of third pressurizing blocks.

14. The manufacturing method for a battery cell of claim 13, further comprising:
a setting operation of determining an elastic modulus of an elastic member connecting the plurality of second pressurizing blocks and the plurality of third pressurizing blocks,
wherein the setting operation includes determining the elastic modulus of the elastic member based on the silicon content of the electrode active material.

15. The manufacturing method for a battery cell of claim 14, wherein the setting operation determines the elastic modulus so that a silicon content of the electrode active material is proportional to the elastic modulus.
